(19) United States
(12) Patent Application Publication
(10) Pub. No.: US 2003/0126227 A1
(43) Pub. Date: Jul. 3, 2003

(54) Method of populating an explicit profile

(75) Inventors: John Zimmerman, Ossining, NY (US); Jacquelyn Martino, Cold Springs, NY (US)

Correspondence Address: PHILIPS ELECTRONICS NORTH AMERICAN CORP, 580 WHITE PLAINS RD, TARRYTOWN, NY, 10591, US

(73) Assignee: KONINKLIJKE PHILIPS ELECTRONICS N.V, Eindhoven (NL)

(21) Appl. No.: 10/040,245

(22) Filed: Dec. 31, 2001

(51) Int. Cl. G06F 15/16

(52) U.S. Cl. 709/217

(57) ABSTRACT

During initialization of an explicit user profile for a recommender system, the user rates only one or more supersets of attributes and/or one or more consistently recurring attributes from the total set of attributes which may be employed by the recommender system to generate suggestions. While viewing lists of subject matter to which the recommender system relates at any time thereafter, the user may view and manipulate individual ratings for all attributes associated with a particular list item. The explicit profile is updated by addition of the item and associated rating value or replacement of the current rating value with the new value entered by the user. The profile may be supplemented with implicit ratings based on the user's viewing history.

### CROSS-REFERENCE TO RELATED APPLICATIONS

The present invention is related to those disclosed in the following U.S. Non-Provisional patent applications:

1) [Docket No. US010684] filed concurrently herewith, entitled “METHOD AND APPARATUS FOR ACCESS AND DISPLAY OF CONTENT ALLOWING USERS TO APPLY MULTIPLE PROFILES”;

2) [Docket No. US010685] filed concurrently herewith, entitled “SORT SLIDER WITH CONTEXT INTUITIVE SORT KEYS”;

3) [Docket No. US010686] filed concurrently herewith, entitled “VISUALIZATION OF ENTERTAINMENT CONTENT.”

The above applications are commonly assigned to the assignee of the present invention. The disclosures of these related patent applications are hereby incorporated by reference for all purposes as if fully set forth herein.

### TECHNICAL FIELD OF THE INVENTION

The present invention is directed, in general, to search systems and, more specifically, to search systems which provide recommendations based on particularized user preferences.

### BACKGROUND OF THE INVENTION

Various “recommenders,” utilities suggesting items to a user based on the user's likes and dislikes, are employed for suggesting television programming, music, books or other items. In suggesting items, such recommenders may employ a specific user's profile, user-independent data regarding relatedness of items, or both. For entertainment content such as video programming, music, books and games, suggestions more likely to match a user's tastes may be provided by recommenders if generated employing, at least in part, an explicit user profile of likes and/or dislikes.

Recommender systems which employ an explicit user profile currently require user entry of a substantial amount of data when the profile is first created, which is often very difficult and/or time-consuming. Systems requiring or allowing users to independently enter the name or title of content force the user to attempt to remember, at the time of profile creation, the names of all relevant content on which suggestions should preferable be based, which is difficult if not impossible. On the other hand, systems displaying a content list to the user from which selections may be made to populate the user's profile typically present a list of an unwieldy size (or risk missing suitable suggestions). For instance, a video programming recommender might require the user to select from a list containing tens of thousands of items. Either alternative (requiring the user to recall relevant items or presenting the user with a comprehensive list), or even a combination of the two approaches, is unduly demanding on the user and requires more time than a user is likely to be willing to spend on the task, and is therefore unsatisfactory.

There is, therefore, a need in the art for an improved approach to gathering item-specific information for an explicit user profile to be used in generating suggestions of suitable items for consideration by the user.

### SUMMARY OF THE INVENTION

To address the above-discussed deficiencies of the prior art, it is a primary object of the present invention to provide, for use in a search system, a recommender system employing an explicit user profile wherein the user, during initialization of the profile, rates only one or more supersets of attributes and/or one or more consistently recurring attributes from the total set of attributes which may be employed by the recommender system to generate suggestions. While viewing lists of subject matter to which the recommender system relates at any time thereafter, the user may view and manipulate individual ratings for all attributes associated with a particular list item. The explicit profile is then updated by addition of the item and associated rating value or replacement of the current rating value with the new value entered by the user. The explicit profile may also be supplemented with implicit ratings based on the user's viewing history. When a user's consumption of a particular type of content exceeds a given threshold, the attributes of such content may be automatically added to the explicit profile.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art will appreciate that they may readily use the conception and the specific embodiment disclosed as a basis for modifying or designing other structures for carrying out the same purposes of the present invention. Those skilled in the art will also realize that such equivalent constructions do not depart from the spirit and scope of the invention in its broadest form.

Before undertaking the DETAILED DESCRIPTION OF THE INVENTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 depicts a content reception system employing user selections to populate an explicit profile according to one embodiment of the present invention;

FIGS. 2A through 2C are mockups of user interface displays for a content reception system controller employing user selections to populate an explicit profile according to one embodiment of the present invention; and

FIG. 3 is a high level flowchart for a process of creating and modifying an explicit user profile via user suggestions in accordance with one embodiment of the present invention.

### DETAILED DESCRIPTION OF THE INVENTION

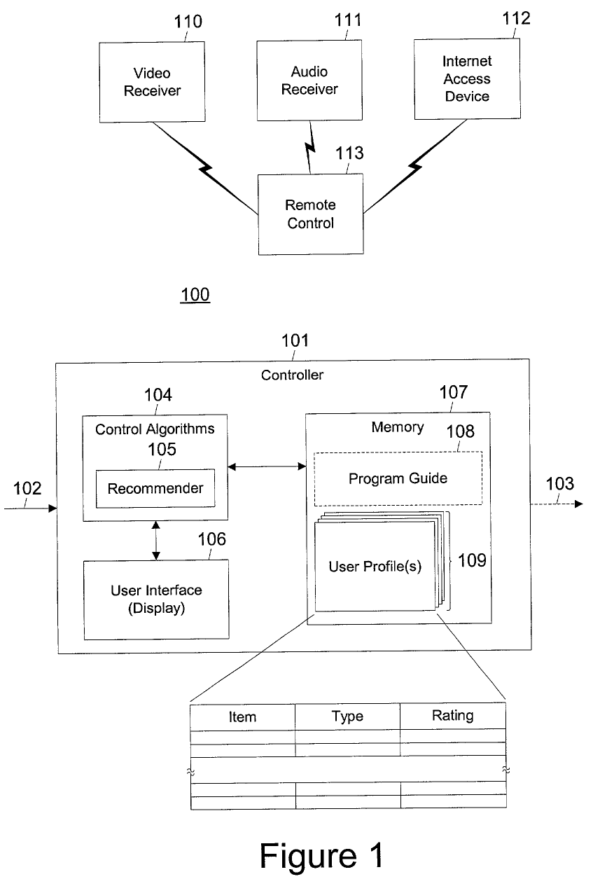

FIGS. 1 through 3, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged device.

FIG. 1 depicts a content reception system employing user selections to populate an explicit profile according to one embodiment of the present invention. Within a content reception system 100, a controller 101 receives at least information regarding content available from one or more external sources (not shown) such as a broadcasting facility or a broadcast or Internet content server, as well as optionally the associated content. Accordingly, controller 101 may be implemented within a video receiver 110 such as a television, a satellite, terrestrial, or cable television broadcast decoder unit, or a digital video recorder, within an audio receiver 111 such as a terrestrial or satellite radio receiver or a compact disc or digital audio player, or within an Internet access device 112 such as a set-top box, a personal computer or the like. Additionally, controller 101 may be implemented within a remote control device 113 adapted for controlling the operation of one or more of the video receiver 110, the audio receiver 111, and the Internet access device 112, and optionally including an integral display and the like. Controller 101 may also be implemented in a distributed fashion, with various portions being disposed within two or more devices forming the video receiver 110, the audio it receiver 111, the Internet access device 112, and the remote control 113.

However implemented, content reception system controller 101 includes an input 102 for receiving at least information regarding content available from the one or more external sources and optionally an output 103 for transmitting content, control signals and/or user interface data to a receiver, display or recording device.

Those skilled in the art will recognize that the full construction and operation of a content reception system controller is not depicted or described herein. Instead, for simplicity and clarity, only so much of the construction and operation of a content reception system controller as is unique to the present invention or necessary for and understanding of the present invention is depicted and described. The remainder of the construction and operation of the controller may follow conventional practices known in the art. Moreover, although a video receiver, an audio receiver, an Internet access device, and a remote control are employed in the exemplary embodiment, those skilled in the art will recognize that the functionality described herein may be readily adapted to other types of devices such as, for example, game devices, and thereby employed with other forms of content.

In the exemplary embodiment, content reception system controller 101 includes a number of control algorithms or programmable logic circuits 104 including a recommender module or functionality 105. A user interface 106 communicably coupled to the controller 104 enables user input from, for example, an infrared remote control, a touch screen, or input buttons. User interface 106 may include a display or, alternatively, controller 101 may be coupled to a separate display device. Controller 101 in the exemplary embodiment also includes a memory 107, preferably nonvolatile. Memory 107 is employed to optionally store information 108 about available content (e.g., a program guide) and to store one or more user profiles 109. User profiles 109 are explicit profiles of user preferences having, associated with each item, an item type and a user rating value for the respective item. Recommender 105 and explicit user profiles 109 may, of course, be located on a remote system from controller 101 and transmit suggestions to controller 101.

In the present invention, rather than requiring a user to select rating values for each individual item at the time of profile creation, the user's explicit profile (i.e., the rating values for all items) may be created or modified in piecemeal fashion over time, based on currently selected content.

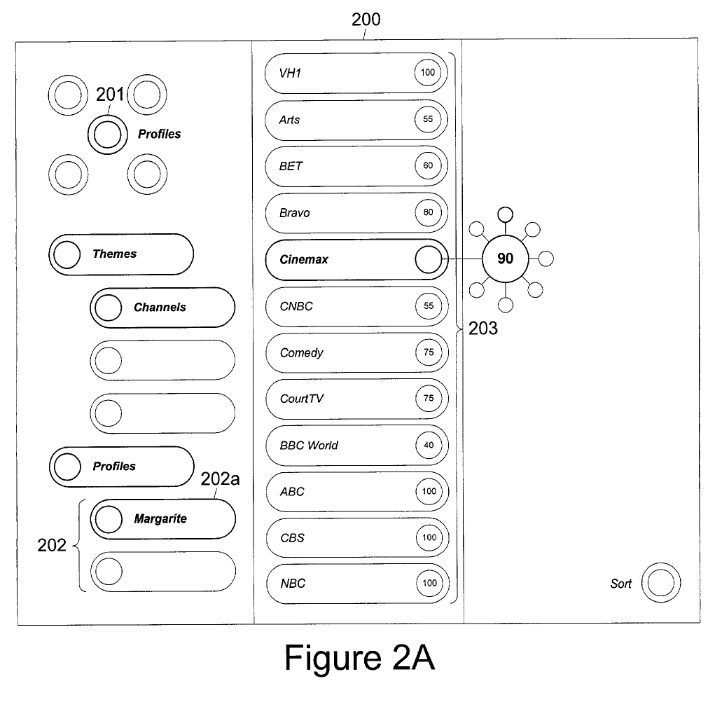

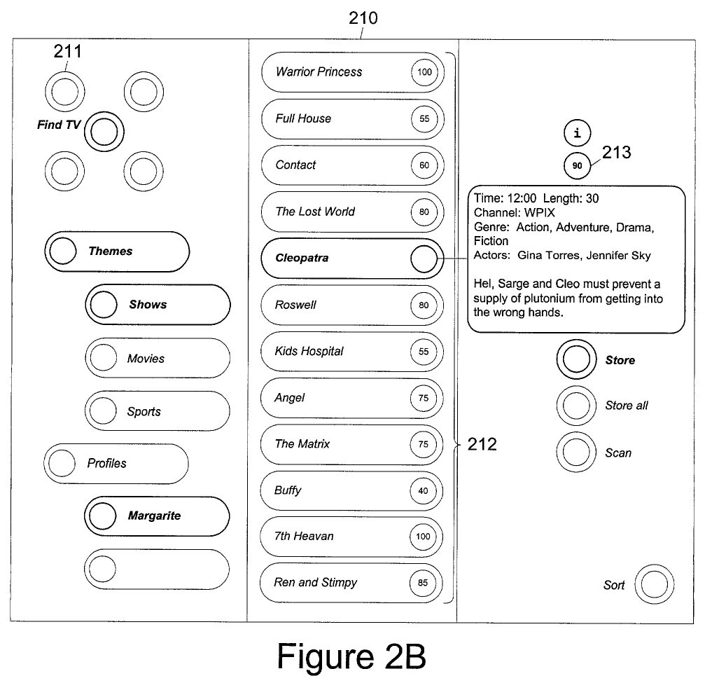

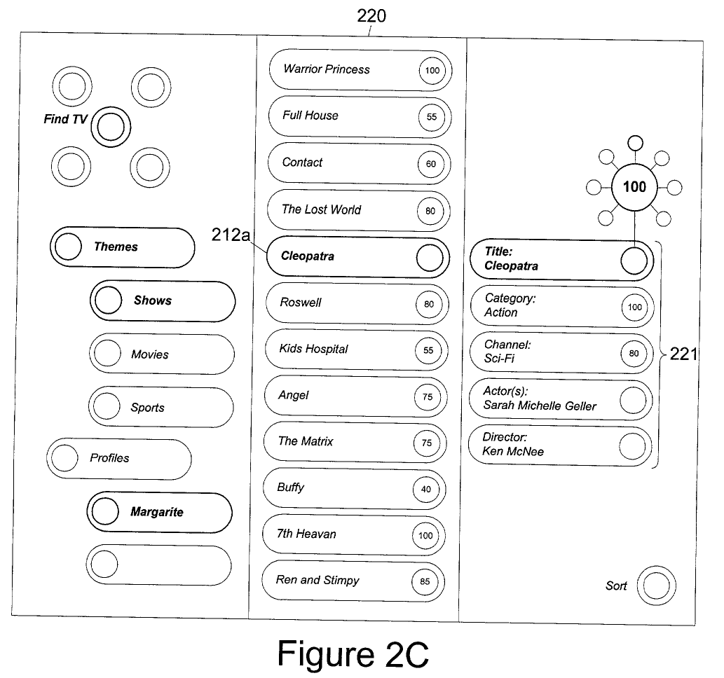

FIGS. 2A through 2C are mockups of user interface displays for a content reception system controller employing user selections to populate an explicit profile according to one embodiment of the present invention. The user interfaces depicted are employed, for example, by controller 101 depicted in FIG. 1. FIG. 2A is a mockup of a user interface display employed during initial creation of an explicit user profile. Among the user controls displayed within user interface display 200 is a control 201 for viewing and creating or modifying an explicit user profile, which are displayed using and may be selected by one or more profile selection controls 202. As with all user controls generally in the exemplary embodiment, the selection control 202a associated with an active or currently selected user profile is highlighted or otherwise differentiated in appearance.

During initial creation of an explicit user profile, the user is presented with the option of rating only one or more supersets of the items to be utilized in generating recommendations, where the supersets may be directly or indirectly related to the items. In the exemplary embodiment involving television broadcasts, the specific items to be utilized in generating recommendations include, for example, television show or movie titles, actors, directors, writers, producers, etc. In creating an explicit user profile, however, the user simply enters ratings for television broadcast channels and genres. A listing of the channels 203 and genres are individually displayed, with user controls allowing entry or other manipulation of a user rating for each channel and/or genre and optionally default rating values (e.g., based on common preferences across a representative sample of users).

The initial ratings entered by the user for channels and genres are then employed by the recommender system to generate content suggestions until changed by the user. Suitable suggestions may be identified in accordance with the known art by determining, for example, the content having the highest (aggregate or average) overall rating and/or by determining content having common characteristics (e.g., same genre) as content having the highest aggregate or average rating.

While numerical ratings of 0 to 100 are employed in the exemplary embodiment, other rating systems may be suitably employed with the present invention, including for example systems permitting assignment of negative ratings to reflect user dislike, systems having narrower rating ranges, and/or systems allowing the user to select a rating value graphically (e.g., by controlling a portion of a bar or pie shape which is “filled”).

FIG. 2B depicts a user interface display 210 during normal selection and viewing of content. A user control 211 is provided within user interface display 210 allowing the user to search currently available programming for particular content. A listing 212 of available content or content matching search criteria is displayed together with the associated aggregate or average rating for each program. By selecting a program within the listing 212, 20 the user may view additional information regarding the selected program (e.g., a more detailed description) and/or access user control 213 for viewing detailed ratings for the selected program and/or one or more items associated with the selected program.

FIG. 2C depicts a user interface display 220 during modification of ratings from an explicit user profile during normal selection and viewing of content and after initial creation of the user profile. By actuating a control 213 while viewing detailed information regarding a particular currently available program 212a, the user may trigger a display 221 of each explicit user profile attribute (or item) associated with that program 212a, together with the current ratings values for each attribute. In the example shown, the selected program has associated therewith a title, category, channel, actor(s) and director. Other categories such as writers, producer, and the like may also be optionally added.

In the exemplary embodiment, the ratings value displays within the listing 221 are themselves user controls for initiating modification of the ratings value associated with the corresponding attribute. By actuating that user control, the user may manipulate the ratings of specific attributes of the selected program, thereby modifying the explicit user profile for the current user through a feedback interface.

Thus, in the exemplary embodiment, the user is shown the program title “Cleopatra” for the currently selected program with a current overall rating of 90 in user interface display 210 of FIG. 2B, and actuates user control 213 to view the detailed ratings breakdown associated with the selected program. The current ratings for each item associated with the selected program, which are the values producing the overall rating of 90, are then displayed in user interface display 220 of FIG. 2C.

The “Channel” and “Category” items were already expressly rated when the user initially created the explicit profile, but may now be altered by the user. In addition, other attributes associated with the selected program are displayed. The user may therefore enter ratings for these additional items, which are then added to the explicit profile for the current user. If an item other than “Channel” or “Category” had previously been rated in connection with a prior program search, that rating may be changed by the user.

Manual ratings by the user may also be supplemented by implicit profile adjustments derived from the user's viewing history without direct intervention by the user. For example, when a user repeatedly selects a particular program from among available content, the attributes associated with that program (or “highly consumed content”) may be automatically added to the explicit profile with predefined rating values, or the existing ratings for such attributes may be modified based, for instance, on the number of times that program was selected. The threshold for transitioning implicit ratings to the explicit profile are based on the user's viewing history. The threshold may be a number of times the associated program was selected by the user, or one or more top percentage brackets of the user's selections may be employed, each with associated ratings. A sliding window of the user's viewing history may be employed to allow attributes on the explicit profile to be removed, reducing the size of the overall profile. When a particular type of content is no longer regularly consumed by the user, the attributes associated with such content may be removed from the explicit profile.

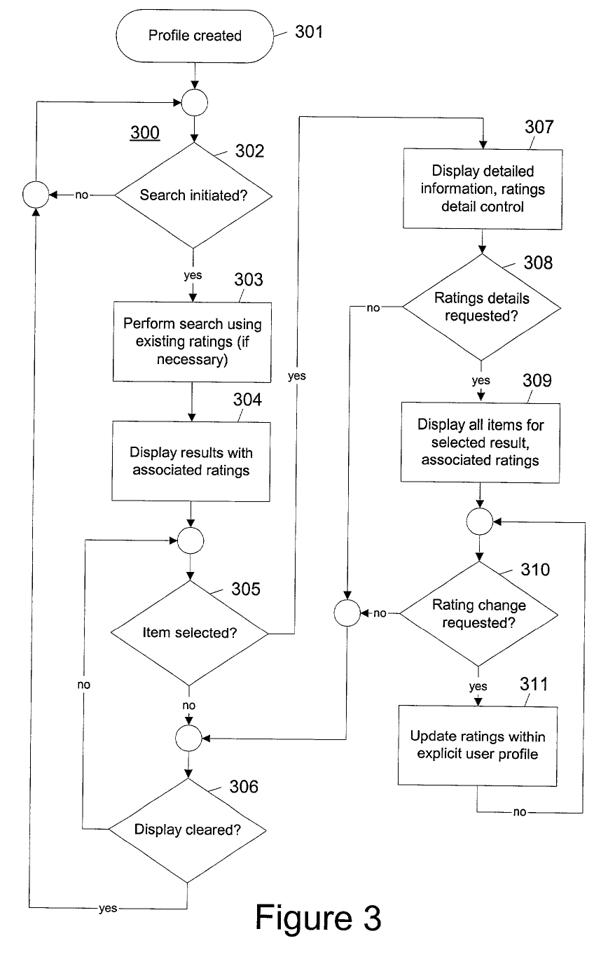

FIG. 3 is a high level flowchart for a process of 1F creating and modifying an explicit user profile via user suggestions in accordance with one embodiment of the present invention. The process 300 begins upon formation of an explicit user profile (step 301) based on user ratings for one or more supersets of items, or one or more consistently recurring attributes defining the search scope (e.g., available channel listing), for use in generating suggestions.

The process first awaits initiation of a user search (step 302), which may be a particularized search for content matching selected criteria or a generalized review of currently available programming. Any requested search is performed (step 303) using existing ratings within the explicit user profile, if needed, and resulting matches are displayed with at least the associated overall ratings from the explicit profile (step 304).

The process then checks for selection of a displayed item within the results list by the user (step 305) or clearing of the display by the user (step 306). When a displayed program within the results list is selected by the user, additional details regarding the program are displayed together with a user control for viewing detailed ratings for the selected program (step 307). If the user control for viewing a detailed ratings breakdown for the selected program is actuated (step 308), all items for the selected program which may be rated are displayed, together with the current ratings, if any, for those items (step 309).

If the user then initiates a rating change request for one of the detailed display items for the selected program (step 310), the explicit profile is updated (step 311) by adding the rated item and associated value or by replacing the existing rating value for that item with the new value entered by the user. The user may manipulate any number of the items associated with the selected program up to and including all of them.

The explicit profile thus becomes more accurate over time by addition of items and associated ratings or by updating or revision of existing ratings. The explicit profile may also be employed in conjunction with automatically captured “historical” data regarding a particular user's viewing habits within a recommender system. Moreover, the recommender system may optionally maintain metadata regarding rating changes by recording, for instance, the program context which prompted user addition of an item to the explicit profile or revision of a rating for an item within the explicit profile, and then subsequently utilize such metadata in evaluating the suitability of particular matches based on the explicit profile.

While the exemplary embodiment relates to a recommender system for television programming, those skilled in the art will recognize that the techniques of the present invention may be readily adapted to other recommender systems such as those making purchase suggestions and the like.

The present invention allows an explicit profile for a recommender system to be created piecemeal over time based on initial ratings for supersets of items to be employed in generating suggestions and any intervening user modifications to add additional items or alter ratings. The user therefore need not remember every relevant item when initially creating the explicit profile, or respond to each item within a lengthy list. Nor does the user need to recall at the time of profile initiation the reasons for their liking or disliking a particular item or aspect thereof. Instead, the user may simply react to the items when encountered in related programming content and enter ratings within a context on which their like or dislike is based.

It is important to note that while the present invention has been described in the context of a fully functional system, those skilled in the art will appreciate that at least portions of the mechanism of the present invention are capable of being distributed in the form of a machine usable medium containing instructions in a variety of forms, and that the present invention applies equally regardless of the particular type of signal bearing medium utilized to actually carry out the distribution. Examples of machine usable mediums include: nonvolatile, hard-coded type mediums such as read only memories (ROMs) or erasable, electrically programmable read only memories (EEPROMs), recordable type mediums such as floppy disks, hard disk drives and compact disc read only memories (CD-ROMs) or digital versatile discs (DVDs), and transmission type mediums such as digital and analog communication links.

Although the present invention has been described in detail, those skilled in the art will understand that various changes, substitutions, variations, enhancements, nuances, gradations, lesser forms, alterations, revisions, improvements and knock-offs of the invention disclosed herein may be made without departing from the spirit and scope of the invention in its broadest form.

What is claimed is:

1. A search system comprising:
an explicit user profile containing user-specific ratings for a plurality of attributes, wherein a user provides rating values for only a subset of the plurality of attributes during initialization of the explicit user profile;
a recommender system employing the explicit user profile in evaluating each of a plurality of search items; and
a controller enabling the user, while viewing information regarding an item subject to evaluation by the recommender system after initialization of the explicit user profile, to manipulate ratings values for each of the plurality of attributes associated with the item.

2. The search system according to claim 1, wherein the user provides rating values during initialization of the explicit user profile for only:
one or more supersets of attributes within the plurality of attributes; or
one or more attributes having possible values defining a scope of all search items.

3. The search system according to claim 1, wherein rating values are included within the explicit user profile based on a content consumption history for the user.

4. The search system according to claim 1, wherein the recommender system employs current values within the explicit user profile in evaluating each of the plurality of search items during a search.

5. The search system according to claim 1, wherein the controller, responsive to the user entering a rating value for an attribute associated with the item, either:
adds the attribute and associated rating value to the explicit user profile if the attribute was not previously rated within the explicit user profile; or
updates the rating value associated with the attribute within the explicit user profile if the attribute was previously rated within the explicit user profile.

6. The search system according to claim 1, wherein the controller enables the user to:
view ratings, if any, for all attributes associated with the item;
add a rating value for an attribute associated with the item which did not previously have a rating value within the explicit user profile; and
revise an existing rating value within the explicit user profile for an attribute associated with the item.

7. A content reception system comprising:
an input for receiving content and a plurality of information items regarding the content;
an explicit user profile containing user-specific rating values for a plurality of attributes, wherein a user provides rating values for only a subset of the plurality of attributes during initialization of the explicit user profile;
a recommender system employing the explicit user profile in evaluating each of the plurality of information items; and
a controller enabling the user, while viewing an information item after initialization of the explicit user profile, to manipulate rating values for each of the plurality of attributes associated with the item.

8. The content reception system according to claim 7, wherein the user provides rating values during initialization of the explicit user profile for only:
one or more supersets of attributes within the plurality of attributes; or
one or more attributes having possible values defining a scope of all information items searched.

9. The content reception system according to claim 7, wherein the recommender system employs current rating values within the explicit user profile in evaluating each of the plurality of information items during a search.

10. The content reception system according to claim 7, wherein the controller, responsive to the user entering a rating value for an attribute associated with the information item, either:
adds the attribute and associated rating value to the explicit user profile if the attribute was not previously rated within the explicit user profile; or
updates a rating value associated with the attribute within the explicit user profile if the attribute was previously rated within the explicit user profile.

11. The content reception system according to claim 7, wherein the controller enables the user to:
view rating values, if any, for all attributes associated with the information item;
add a rating value for an attribute associated with the information item which did not previously have a rating value within the explicit user profile; and
revise an existing rating value within the explicit user profile for an attribute associated with the information item.

12. A method of searching information items comprising:
receiving content and a plurality of information items regarding the content;
employing an explicit user profile containing user-specific rating values for a plurality of attributes in evaluating each of the plurality of information items, wherein a user provides rating values for only a subset of the plurality of attributes during initialization of the explicit user profile; and
allowing the user, while viewing an information item after initialization of the explicit user profile, to manipulate rating values for each of the plurality of attributes associated with the item.

13. The method according to claim 12, wherein the user provides rating values during initialization of the explicit user profile for only:
one or more supersets of attributes within the plurality of attributes; or
one or more attributes having possible values defining a scope of all information items searched.

14. The method according to claim 12, wherein the recommender system employs current rating values within the explicit user profile in evaluating each of the plurality of information items during a search.

15. The method according to claim 12, wherein, in response to the user entering a rating value for an attribute associated with the information item, either:
the attribute and associated rating value are added to the explicit user profile if the attribute was not previously rated within the explicit user profile; or
a rating value associated with the attribute within the explicit user profile is updated if the attribute was previously rated within the explicit user profile.

16. The method according to claim 12, wherein the user is permitted to:
view rating values, if any, for all attributes associated with the information item;
add a rating value for an attribute associated with the information item which did not previously have a rating value within the explicit user profile; and
revise an existing rating value within the explicit user profile for an attribute associated with the information item.

17. A signal comprising:
a listing of content suggestions relating to content and a plurality of information items regarding the content,
wherein the listing of content suggestions is generated by employing an explicit user profile containing user-specific rating values for a plurality of attributes in evaluating each of the plurality of information items,
wherein a user provides rating values for only a subset of the plurality of attributes during initialization of the explicit user profile,
wherein the user, while viewing an information item after initialization of the explicit user profile, is permitted to selectively manipulate rating values for each of the plurality of attributes associated with the item.

18. The signal according to claim 17, wherein the user provides rating values during initialization of the explicit user profile for only:
one or more supersets of attributes within the plurality of attributes; or
one or more attributes having possible values defining a scope of all information items searched.

19. The signal according to claim 17, wherein current rating values within the explicit user profile are employed in evaluating each of the plurality of information items during a search.

20. The signal according to claim 17, wherein, in response to the user entering a rating value for an attribute associated with the information item, either:
the attribute and associated rating value are added to the explicit user profile if the attribute was not previously rated within the explicit user profile; or
a rating value associated with the attribute within the explicit user profile is updated if the attribute was previously rated within the explicit user profile.

21. The signal according to claim 17, wherein the user is permitted to:
view rating values, if any, for all attributes associated with the information item;
add a rating value for an attribute associated with the information item which did not previously have a rating value within the explicit user profile; and
revise an existing rating value within the explicit user profile for an attribute associated with the information item.
